(19) United States
(12) Patent Application Publication
(10) Pub. No.: US 2007/0030513 A1
(43) Pub. Date: Feb. 8, 2007

(54) Image output apparatus and image output method

(75) Inventors: Yoshinao Kitahara, Nagano (JP); Hideki Morozumi, Nagano (JP); Kenji Sakuda, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/495,645

(22) Filed: Jul. 31, 2006

(30) Foreign Application Priority Data
Jul. 29, 2005 (JP) P2005-220162

(51) Int. Cl. G06F 3/12

(52) U.S. Cl. 358/1.15

(57) ABSTRACT

An image output apparatus includes a first communicator, operable to receive a first image output request transmitted from a first image output request apparatus by a first communication method; a second communicator, operable to receive a second image output request transmitted from a second image output request apparatus by a second communication method; a controller, operable to select one of the first image output request and the second image output request in a case where the first image output request and the second image output request conflict; and a processor, operable to generate control information for performing image output in accordance with the selected image output request.

### BACKGROUND OF THE INVENTION

The present invention relates to an image output apparatus and an image output method.

“White Paper of CIPA DC-001-2003 Digital Photo Solutions for Imaging Devices (Japanese)” (Camera & Imaging Products Association, Feb. 3, 2003, that is Nonpatent Document) discloses a direct printing system according to PictBridge. In the direct printing system, a digital still camera and a printer are connected directly without going through a personal computer. The digital still camera transmits an image printing request to the printer. The printer interprets the printing request and executes a printing of an image.

At present, in a direct printing system, a digital still camera (DSC) and a printer are directly connected in a one-on-one relation by a USB (Universal Serial Bus) cable. Recently, a PTP/IP (PTP over IP) with a PTP (Photo Transfer Protocol) corresponding to a TCP/IP (Transmission Control Protocol/Interference Protocol) has been proposed. At this point, carrying out a direct printing via an IP network by making the DSC and the printer compatible with an IP network connection can be considered.

However, in the event that a printer compatible with the direct printing system is simply made compatible with the network connection, the following kind of problem can be predicted. In the event that a printer compatible with the direct printing system is made compatible with a direct printing via the network, the printer will be equipped with a network connector for connecting a network cable, as well as a USB connector for connecting a USB cable.

For this reason, it is possible that the printer which is compatible with the direct printing via the network is simultaneously connected by the USB cable and the network cable. Then, in the event that the DSC connected by the USB cable and the DSC connected via the network cable are connected simultaneously, it is possible that the image output requests from the plurality of DSCs conflict in the printer, meaning that an image based on the image output request is not printed appropriately.

### SUMMARY

It is therefore an object of the invention to provide an image output apparatus and an image output method wherein it is possible to appropriately output an image based on the image output request, even though the image output request from a USB etc. and the image output request from a network conflict.

In order to achieve the object, according to the invention, there is provided an image output apparatus comprising:

a first communicator, operable to receive a first image output request transmitted from a first image output request apparatus by a first communication method;

a second communicator, operable to receive a second image output request transmitted from a second image output request apparatus by a second communication method;

a controller, operable to select one of the first image output request and the second image output request in a case where the first image output request and the second image output request conflict; and

a processor, operable to generate control information for performing image output in accordance with the selected image output request.

With this configuration, by having two image output request apparatuses each of which supplies the image output request to the image output apparatus which outputs the image in accordance with the image output request, even in the event that the image output requests conflict, it is possible to appropriately output the image based on either of the image output requests, with no danger of one of the image output requests having a bad effect on the other image output request.

The processor may detect the first image output request apparatus based on a first communication path between the first communicator and the first image output request apparatus. The processor may detect the second image output request apparatus based on a second communication path between the second communicator and the second image output request apparatus. The controller may select the first image output request in a case where the first communication path is established before the second communication path is established. The controller may select the second image output request in a case where the second communication path is established before the first communication path is established.

In this case, as an exclusive control is carried out in the communication layer near a physical layer, there is no need to make the upper communication layers parallel for two systems of communication with the first image request apparatus and the second image request apparatus, meaning that the processing becomes easy, and the processor etc. which forms the upper layer can be easily installed.

The first communicator may establish a first communication path between the first communicator and the first image output request apparatus. The second communicator may establish a second communication path between the second communicator and the second image output request apparatus. The processor may detect the first image output request apparatus based on the first communication path. The processor may detect the second image output request apparatus based on the second communication path. The controller may select the first image output request in a case where the first communication path is detected before the second communication path is detected. The controller may select the second image output request in a case where the second communication path is detected before the first communication path is detected.

In this case, there is no need to make parallel the processor which forms the upper layer, meaning that it can be easily installed. Also, a communication layer between the first communicator and the first image output request apparatus and a communication layer between the second communicator and the second image output request apparatus, which form a lower layer, are made parallel, meaning that two systems can be simultaneously connected in the lower layer. Therefore, in the event that images are outputted consecutively from differing systems, there is no need to carry out an establishment of the communication path in the lower layer again, and it is possible to immediately supply the image output request to the processor.

The first communicator may establish a first communication path between the first communicator and the first image output request apparatus. The second communicator may establish a second communication path between the second communicator and the second image output request apparatus. The processor may detect the first image output request apparatus based on the first communication path. The processor may detect the second image output request apparatus based on the second communication path. The controller may select the first image output request in a case where the first image output request apparatus starts to transmit the first image output request before the second image output request apparatus starts to transmit the second image output request. The controller may select the second image output request in a case where the second image output request apparatus starts to transmit the second image output request before the first image output request apparatus starts to transmit the first image output request.

In this case, the processor is made parallel, meaning that two systems can be simultaneously connected in the processor which forms an upper layer. Therefore, in the event that images are outputted consecutively from differing systems, there is no need to carry out an establishment of the communication path in the upper layer and the lower layer again, and it is possible to immediately supply the image output request to the processor. Also, a connection condition is maintained between the image output request apparatus in which the image output based on the image output request is not being carried out and the processor. Therefore, it is possible to carry out a setting process etc. of the image output between them while the image output based on the image output request from another image output request apparatus is being executed.

The first communicator may establish a first communication path between the first communicator and the first image output request apparatus. The second communicator may establish a second communication path between the second communicator and the second image output request apparatus. The processor may detect the first image output request apparatus based on the first communication path. The processor may detect the second image output request apparatus based on the second communication path. The controller may include a queuer which queues the first image output request and the second image output request.

In this case, by having two image output request apparatuses each of which supplies the image output request to the image output apparatus which outputs the image in accordance with the image output request, even in the event that the image output requests conflict, it is possible to appropriately output the images sequentially based on each of the image output requests by means of the queuing.

Until the image output based on one of the first image output request and the second image output request is finished, the controller may block the other one of the first image output request and the second image output request.

In this case, while the image output based on the image output request from one of the image output request apparatuses is being carried out, even in the event that the image output request from the other of the image output request apparatuses is outputted, there is no danger of a bad effect on the image output at that point.

The controller may preferentially select one of the first image output request and the second image output request based on a predetermined set order.

In this case, for example, in the event that two image output requests are received by the first communicator etc., in the event that the image output based on the image output request received first has not yet started, it is possible to give priority to the image output request received later in response to the image output request apparatus which transmitted it.

In order to achieve the object, according to the invention, there is provided an image output method comprising:

receiving a first image output request from a first image output request apparatus;

receiving a second image output request from a second image output request apparatus;

selecting one of the first image output request and the second image output request in a case where the first image output request and the second image output request conflict; and

generating control information for performing image output in accordance with the selected image output request.

With this configuration, by having two image output request apparatuses each of which supplies the image output request to the image output apparatus which outputs the image in accordance with the image output request, even in the event that the image output requests conflict, it is possible to appropriately output the image based on either of the image output requests, with no danger of one of the image output requests having a bad effect on the other image output request.

### BRIEF DESCRIPTION OF THE DRAWINGS

FIG. 1 is a hardware configuration diagram of a printer according to an embodiment 1 of the invention;

FIG. 2 is a diagram showing a direct printing system having the printer in FIG. 1;

FIG. 3 is an example of a print job received by a DPDP layer of the printer;

FIG. 4 is a diagram showing a direct printing system according to an embodiment 2 of the invention;

FIG. 5 is a diagram showing a direct printing system according to an embodiment 3 of the invention; and

FIG. 6 is a diagram showing a direct printing system according to an embodiment 4 of the invention.

### DETAIL DESCRIPTION OF PREFERRED EMBODIMENTS

Hereafter, a description of an image output apparatus and an image output method according to embodiments of the invention will be given with reference to the drawings. The image output apparatus will be described as a printer of a direct printing system. The image output method will be described as an operation of the printer.

### Embodiment 1

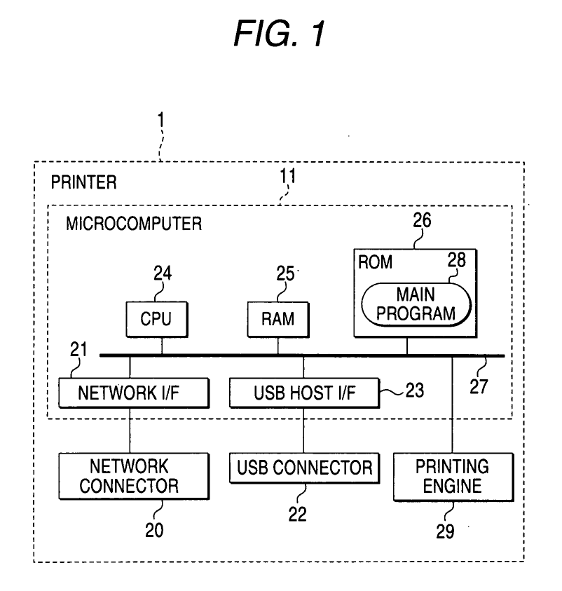

FIG. 1 is a hardware configuration diagram of a printer 1 as an image output apparatus according to an embodiment 1 of the invention. The printer 1 has a microcomputer 11. The microcomputer 11 includes a network I/F (interface) 21, a USB host I/F 23, a central processing unit (CPU) 24, an RAM (Random Access Memory) 25, an ROM 26, and a system bus 27 connecting them. The ROM 26 stores a main program 28. Apart from the above, a printing engine 29 is connected to the system bus 27 via a not-shown input-output port.

The network I/F 21 is connected to a network connector 20. The network I/F 21 sends data to be transmitted from the network connector 20. The network I/F 21 receives a signal from the network connector 20, thereby receiving data superimposed on the signal.

The USB host I/F 23 is connected to a USB connector 22. The USB host I/F 23 manages communication by a USB of an instrument connected to the USB connector 22. The USB host I/F 23 manages communication with the instrument connected to the USB connector 22. Also, the USB host I/F 23 executes a connection process by the USB in the event that there is a connection request.

The printing engine 29 is a device which prints an image etc. on a paper. As the printing engine 29, there is an ink jet printing engine etc. The ink jet printing engine 29 has a mechanism which conveys the paper to a printing position, a mechanism which ejects ink onto the paper in the printing position, etc.

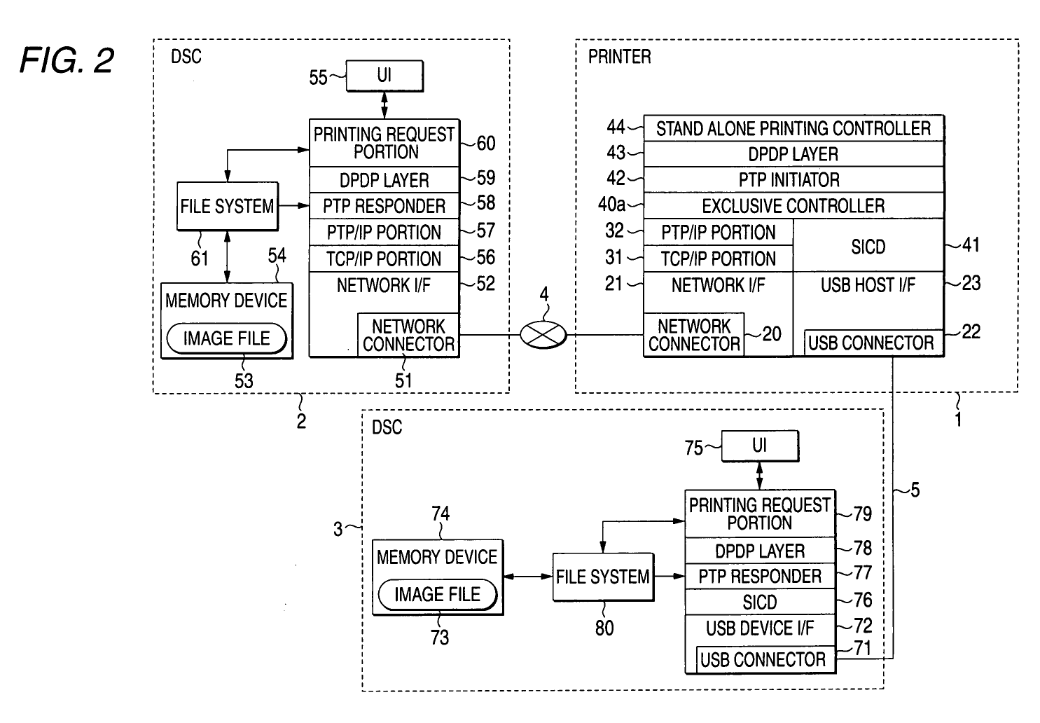

FIG. 2 is a diagram showing a direct printing system wherein a DSC (Digital Still Camera) 2 and a DSC 3 are connected to the printer 1 in FIG. 1.

The DSC 2 is connected to the network connector 20 of the printer 1 via a communication network 4. As the communication network 4, there is an LAN (Local Area Network) such as, for example, an Ethernet (a registered trademark). In this case, it is acceptable that a large-scale network, such as an internet, an electrical communication line, an ATM exchange network or a wireless communication network, is included in a plurality of communication networks 4 as a part thereof.

The DSC 3 is connected to the USB connector 22 of the printer 1 by a USB cable 5.

The central processing unit 24 of the microcomputer 11 of the printer 1 loads the main program 28 stored in the ROM 26 onto the RAM 25 and executes it, thereby actualizing, in the printer 1, an exclusive controller 40a, a TCP/IP portion 31, a PTP/IP portion 32, an SICD (Still Image Capture Device) 41, a PTP initiator 42, a DPDP layer 43, and a stand alone printing controller 44.

The TCP/IP portion 31 generates a TCP/IP packet, and carries out a transmission and reception of the packet with another TCP/IP portion (for example, a TCP/IP portion 56 of the DSC 2 to be described hereafter).

The PTP/IP portion 32 carries out a transmission and reception of a PTP command, a PTP response, image data and so on, based on a PTP, with another PTP/IP portion (for example, a PTP/IP portion 57 of the DSC 2 to be described hereafter).

The SICD 41, having a configuration based on an SICD class of the USB, has an end point. The end points include one for an input, an output, a control, etc. The SICD 41 carries out a transmission and reception of data between previously correlated end points.

The PTP initiator 42 transmits the PTP command to PTP responders 58 and 77. The PTP responders 58 and 77 transmit the PTP response to the PTP initiator 42. As the PTP command, there are a GetObject, a GetPartialObject and so on for obtaining an image file. A file ID issued one-for-one with the image file is specified in the GetObject and GetPartialObject. The PTP responders 58 and 77, on receiving the GetObject and GetPartialObject, transmit files, such as the image file specified by the file ID, and an XML script file in the DPDP layer to be described hereafter, to the PTP initiator 42.

The DPDP layer 43 generates an operation script and a response script described in XML (eXtensible Markup Language), which is one kind of markup language, and carries out a transmission and reception thereof with another DPDP layer (for example, DPDP layers 59 and 78 to be described hereafter). As the DPDP operation script, there is, for example, a print job which requests a printing of an image. This kind of XML script file is transmitted and received in the DPDP layer which controls a direct printing process.

The exclusive controller 40a, in the event that the image output request from the DSC 2 and the image output request from the DSC 3 conflict, exclusively selects one of them, and supplies the selected image output request to DPDP layer 43. Furthermore, in the embodiment 1, the exclusive controller 40a selects the image output request from whichever communication path of the DSC 2 and TCP/IP portion 31 communication path and the DSC 3 and SICD 41 communication path is established first.

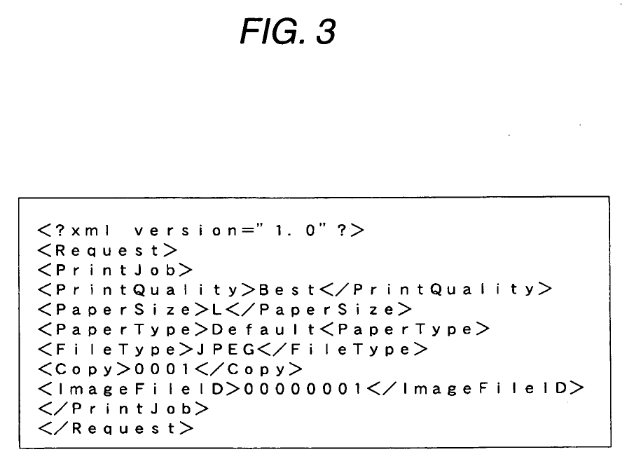

FIG. 3 is a diagram showing an example of the XML script of the print job received by the DPDP layer 43.

XML version information is described at a head of the print job as the image output request. After the XML version information, printing condition information which specifies printing conditions of the image is described. In the example in FIG. 3, a high quality (Best) is specified as a printing quality (PrintQuality), an L-size (L) is specified as a paper size (PaperSize), a standard (Default) is specified as a paper type (PaperType), a JPEG is specified as an image file type, once (0001) is specified as a number of printings (Copy), and 00000001 is specified as an image file identification number (ImageFileID).

The plurality of printing request values is enclosed by tags (for example, <PrintQuality>, </PrintQuality>) corresponding to each printing setting item. The plurality of sets of printing request values and tags is further enclosed by a tag group (<Request> <Print Job> and </PrintJob> </Request>) showing that the whole is an image printing request.

The stand alone printing controller 44 controls the printing engine 29 based on a printing command. The stand alone printing controller 44 controls the printing engine 29 in such a way that it prints an image of the quality specified by the printing command value, on the paper specified by the printing command value, according to a layout specified by the printing command value.

The DSC 2 connected to the printer 1 via the communication network 4 in FIG. 2 has a network I/F 52 which has a network connector 51, a memory device 54 which stores an image file 53, a UI (User Interface) 55, and a not-shown central processing unit. Also, the not-shown central processing unit of the DSC 2, by executing a not-shown direct printing program, actualizes the TCP/IP portion 56, the PTP/IP portion 57, the PTP responder 58, the DPDP layer 59, a printing request portion 60 and a file system 61.

The memory device 54 stores, for example, image data of a semi-conductor memory, a hard disc drive etc. The file system 61 manages the memory device 54. The file system 61 recognizes, in an image unit, the image data stored in the memory device 54 as the image file.

The UI 55 has a not-shown liquid crystal device and operating key device. The liquid crystal device displays the image based on display data. The operating key device generates input data in accordance with a key operation.

The printing request portion 60 identifies information of the image printing request. The printing request portion 60, for example, displays the image of the image file 53 stored in the memory device 54 in the liquid crystal device. The printing request portion 60, when input data which signifies a selection is input from the operating key device in the display condition, selects the image being displayed as an image to be printed. The printing request portion 60 identifies details of the image printing request in accordance with selection details, and supplies the information to the DPDP layer 59.

As the network I/F 52, the TCP/IP portion 56, the PTP/IP portion 57, the PTP responder 58 and the DPDP layer 59 of the DSC 2 have functions identical to those of the printer 1 components of the same name, a description will be omitted here.

The DSC 3 connected to the printer 1 via the USB cable 5 in FIG. 2 has a USB device I/F 72 which has a USB connector 71, a memory device 74 which stores an image file 73, a UI 75, and a not-shown central processing unit. Also, the not-shown central processing unit of the DSC 3, by executing a not-shown direct printing program, actualizes an SICD 76, the PTP responder 77, the DPDP layer 78, a printing request portion 79 and a file system 80. As each component of the DSC 3 has a function identical to that of the printer 1 and DSC 2 component of the same name, a description will be omitted here.

Next, a description will be given of an operation of each instrument of the direct printing system having the configuration described heretofore. First, a description will be given of a case in which the DSC 2 is connected to the printer 1 before the DSC 3 is, after which a description will be given of a case in which the DSC 3 is connected to the printer 1 before the DSC 2 is.

The TCP/IP portion 31, the PTP/IP portion 32, the exclusive controller 40a, the PTP initiator 42, and the DPDP layer 43 are stacked sequentially in an upper part of the network I/F 21 of the printer 1. Also, the TCP/IP portion 56, the PTP/IP portion 57, the PTP responder 58, and the DPDP layer 59 are stacked sequentially in an upper part of the network I/F 52 of the DSC 2.

In this way, the communication path is established between the TCP/IP portion 56 of the DSC 2 and the TCP/IP portion 31 of the printer 1, thereby enabling a mutual transmission and reception of the TCP/IP packet. A mutual transmission and reception of the PTP command, PTP response, image data, etc. becomes possible between the PTP/IP portion 57 of the DSC 2 and the PTP/IP portion 32 of the printer 1. The PTP initiator 42 of the printer 1 becomes able to transmit the PTP command to the PTP responder 58 of the DSC 2. The PTP responder 58 of the DSC 2 becomes able to transmit the PTP response and the image data to the PTP initiator 42 of the printer 1.

When, for example, communication is detected at a prescribed port of the TCP in the TCP/IP portion 31, the exclusive controller 40a determines that the communication by the communication network 4 has become possible. Then, after determining thus, in the event that the DSC 3 is connected, the exclusive controller 40a blocks the PTP command etc. from the DSC 3, to be described hereafter, and does not supply it to the PTP initiator 42. That is, while the DSC 2 is connected at the TCP, the PTP command etc. from the DSC 3 is blocked.

By means of the connection process described heretofore, data communication becomes possible exclusively between the DSC 2 and the printer 1.

The DPDP layer 59 of the DSC 2 and the DPDP layer 43 of the printer 1 start a connection process in the DPDP layer when the PTP responder 58 and the PTP initiator 42 in their respective lower parts become capable of communication. In the connection process, the DPDP layers 43 and 59, firstly, transmit detection data for detecting the DPDP layer which is to be a communication partner to the PTP responder 58 or the PTP initiator 42 in the lower part.

For example in the DSC 2, when the PTP responder 58 becomes capable of communication, the DPDP layer 59 supplies the detection data for detecting the DPDP layer 43 to the PTP responder 58. The detection data supplied to the PTP responder 58 is supplied to the network I/F 52 via the PTP/IP portion 57 and the TCP/IP portion 56. The network I/F 52 of the DSC 2 sends the TCP/IP packet of the supplied detection data from the network connector 51 to the communication network 4. The network I/F 2i of the printer 1 receives the TCP/IP packet sent to itself from the communication network 4.

The TCP/IP packet received by the network I/F 21 of the printer 1 is supplied to the TCP/IP portion 31. The TCP/IP portion 31 extracts the data, that is, the detection data, from the TCP/IP packet, and supplies it to the PTP initiator 42 via the PTP/IP portion 32. The PTP initiator 42 supplies the detection data received to the DPDP layer 43.

By means of the series of operations heretofore described, the detection data generated and transmitted by the DPDP layer 59 of the DSC 2 is received by the DPDP layer 43 of the printer 1.

The DPDP layer 43 of the printer 1, on receiving the detection data, starts a connection process. The DPDP layer 43 transmits response data to the DPDP layer 59 of the DSC 2. By this means, the DPDP layer 43 of the printer 1 recognizes that the DPDP layer 59 of the DSC 2 has been connected, and the DPDP layer 59 of the DSC 2 recognizes that the DPDP layer 43 of the printer 1 has been connected. It becomes possible for control information for the image printing in the DPDP layer to be transmitted and received between the DPDP layer 43 of the printer 1 and the DPDP layer 59 of the DSC 2, whereby the direct printing via the communication network 4 becomes possible. When transmitting and receiving the detection data and the response data, in the PTP layer, either the detection data and the response data of the DPDP layer are each transmitted and received as one file, or a PTP command corresponding to each of the detection data and the response data is transmitted and received.

Subsequently, when the image file 53 to be printed and the printing conditions are determined by a user operating the UI 55, the printing request portion 60 supplies the information to the DPDP layer 59. The DPDP layer 59 generates a print job which is an image output request, such as the one in FIG. 3, based on the information. This image output request is treated as one XML script text file.

The DPDP layer 59 of the DSC 2 transmits the generated print job to the DPDP layer 43 of the printer 1. Specifically, the print job generated by the DPDP layer 59 of the DSC 2 is sent as the TCP/IP packet from the network I/F 52 to the communication network 4 via the PTP responder 58, the PTP/IP portion 57 and the TCP/IP portion 56.

The TCP/IP packet is received by the network I/F 21 of the printer 1. The TCP/IP portion 31 extracts the print job from the TCP/IP packet, and supplies it to the PTP initiator 42 via the PTP/IP portion 32. The PTP initiator 42 supplies the print job received to the DPDP layer 43.

By means of the series of operations heretofore described, the print job generated by the DPDP layer 59 of the DSC 2 is supplied to the DPDP layer 43 of the printer 1.

The DPDP layer 43 of the printer 1, on the print job being supplied from the DSC 2, generates a printing command corresponding to the print job. In the case of the print job in FIG. 3, the DPDP layer 43, for example, generates the printing command to print one copy of the image in the image file of identification number 000001, at a high quality, on the whole surface of L-sized paper. The DPDP layer 43 supplies the printing command generated to the stand alone printing controller 44. Also, the DPDP layer 43 obtains the image file 53 of the file ID specified in the print job from the DSC 2. At this time, the PTP initiator 42 transmits a transmission request for the image file 53. The transmission request is received by the PTP responder 58 of the DSC 2 via the communication network 4 etc. The PTP responder 58 transmits the image file 53 related to the transmission request to the PTP initiator 42.

The stand alone printing controller 44, firstly, generates control data for the printing engine 29 corresponding to the printing command supplied. Specifically, the stand alone printing controller 44, for example, generates a printing image, for each colour of printing ink, for the paper size to be printed upon, from the data of the image to be printed and, by carrying out a binarization process, an interlacing process etc. for the printing image, generates control data. The stand alone printing controller 44, using the control data generated, controls the printing engine 29. The printing engine 29 executes the printing process in accordance with the control of the stand alone printing controller 44. By this means, the printer 1 prints the image requested by the DSC 2.

Next, a description will be given of the case in which the DSC 3 is connected to the printer 1 before the DSC 2 is.

The USB connectors 22 and 71 of the printer 1 and the DSC 3 are connected by the USB cable 5. The SICD 41, the exclusive controller 40a, the PTP initiator 42, and the DPDP layer 43 are stacked sequentially in an upper part of the USB host I/F 23 of the printer 1. Also, the SICD 76, the PTP responder 77, and the DPDP layer 78 are stacked sequentially in an upper part of the USB device I/F 72 of the DSC 3.

When the USB cable 5 is connected to the USB device I/F 72, the SICD 76 of the DSC 3 transmits a set interface command to the SICD 41 of the printer 1. The set interface command is transmitted to the SICD 41 via the USB device I/F 72 and the USB host I/F 23 of the printer 1. The SICD 76 of the DSC 3 and the SICD 41 of the printer 1 each generate an end point.

In this way, an end point to end point communication path is established between the SICD 76 of the DSC 3 and the SICD 41 of the printer 1, whereby a transmission and reception of the data becomes possible. Consequently, it becomes possible for the PTP initiator 42 of the printer 1, in an upper layer of the USB, and the PTP responder 77 of the DSC 3, to transmit and receive data such as the PTP command.

At this time, as the DSC 2 is not connected to the printer 1 at the TCP, the exclusive controller 40a supplies the PTP command etc. from the DSC 3 as they are to the PTP initiator 42. Subsequently, in the event that the DSC 2 is connected to the printer 1, the exclusive controller 40a blocks the PTP command etc. from the DSC 2, and does not supply it to the PTP initiator 42. That is, in the event that the PTP command from the DSC 3 is detected, the PTP command etc. from the DSC 2 is blocked until the image output (the printing) is finished.

The DPDP layer 78 of the DSC 3 and the DPDP layer 43 of the printer 1 start a DPDP layer connection process when the PTP responder 77 and the PTP initiator 42 in their respective lower parts become capable of communication. In the connection process, the detection data and response data used is transmitted and received via the PTP responder 77 of the DSC 3, the SICD 76, the USB device I/F 72, the USB cable 5, the USB host I/F 23 of the printer 1, the SICD 41, and the PTP initiator 42. By this means, it becomes possible for the control information for the image printing in the DPDP layer to be transmitted and received between the DPDP layer 43 of the printer 1 and the DPDP layer 78 of the DSC 3, whereby the direct printing via the USB cable 5 becomes possible.

The printing request portion 79 of the DSC 3 carries out a selection process for printing the image in the image file 73 stored in the memory device 74, and supplies selection information to the DPDP layer 78. The DPDP layer 78 of the DSC 3 generates a print job corresponding to the selection information, and transmits it to the DPDP layer 43 of the printer 1.

The print job is received by the DPDP layer 43 via the DPDP layer 78 of the DSC 3, the PTP responder 77, the SICD 76, The USD device I/F 72, the USB cable 5, the USB host I/F 23 of the printer 1, the SICD 41, and the PTP initiator 42.

The DPDP layer 43 of the printer 1, on the print job being supplied from the DSC 3, as well as generating a printing command corresponding to the print job, obtains the image file 73 specified in the print job from the DSC 3, and supplies it to the stand alone printing controller 44.

The stand alone printing controller 44, firstly, generates control data for the printing engine 29 corresponding to the printing command supplied, and controls the printing engine 29 using the control data generated. The printing engine 29 executes the printing process in accordance with the control of the stand alone printing controller 44. By this means, the printer 1 prints the image requested by the DSC 3.

As described heretofore, according to the embodiment 1, the printer 1 includes the DPDP layer 43 which, in accordance with the image output request, generates the control information for outputting the image based on the image data specified by the image output request, and also includes the SICD 41 which receives the image output request from the DSC 3 which requests the output of the image based on the image data on the USB. Furthermore, the printer 1, being connected to the communication network 4, which is the IP network, includes the TCP/IP portion 31 and the PTP/IP portion 32 which receive the image output request from the DSC 2 via the communication network 4, and the exclusive controller 40a which, in the event that the image output request from the DSC 3 and the image output request from the DSC 2 conflict, exclusively selects one thereof, and causes the DPDP layer 43 to process the selected image output request.

By this means, by having two DSCs each of which supplies the image output request to the printer 1, even in the event that the image output requests conflict, it is possible to appropriately output the image based on either of the image output requests, with no danger of one of the image output requests having a bad effect on the other image output request.

Also, according to the embodiment 1, the DPDP layer 43a detects the DSC 2 or the DSC 3 by using the communication path via the communication network 4 between the DSC 2 and the TCP/IP portion 31, or the USB communication path between the DSC 3 and the SICD 41. Then, the exclusive controller 40a selects the image output request from whichever communication path of the DSC 2 and TCP/IP portion 31 with the communication network 4 communication path and the DSC 3 and SICD 41 with the USB communication path is established first.

By this means, as the exclusive control is carried out in the communication layer near a physical layer, there is no need to make parallel, such as by multithreading, the DPDP layer and the PTP layer, which are upper communication layers, for two systems of communication with the DSC 2 and communication with the DSC 3, meaning that the processing becomes easy, and the DPDP layer 43 etc. which form the upper layer can be easily installed.

### Embodiment 2

An image output apparatus according to an embodiment 2 of the invention is configured in such a way that, in the printer 1 of the embodiment 1, PTP initiators are arranged in a series, and an exclusive controller 40b is disposed between the PTP initiators and a DPDP layer, instead of the exclusive controller 40a.

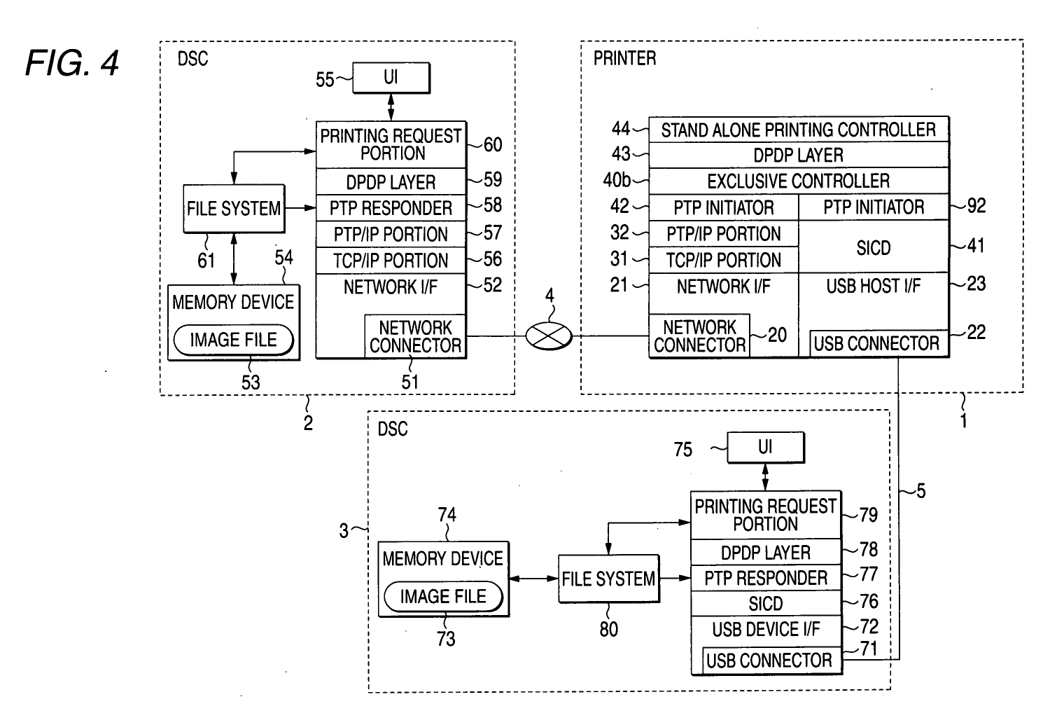

FIG. 4 is a block diagram showing a direct printing system including the printer 1 as the image output apparatus according to the embodiment 2. A hardware configuration of the printer 1 as the image output apparatus according to the embodiment 2 is identical to that in the embodiment 1. However, the main program 28 is changed to one which actualizes functions described hereafter.

The printer 1 has a network I/F (interface) 21, a TCP/IP portion 31, a PTP/IP portion 32, a USB host I/F 23, an SICD 41, two PTP initiators 42 and 92, the exclusive controller 40b, a DPDP layer 43 and a stand alone printing controller 44. As a central processing unit 24 of a microcomputer 11 of the printer 1 loads the main program 28 stored in an ROM 26 into an RAM 25 and executes it, the TCP/IP portion 31, the PTP/IP portion 32, the SICD 41 and the two multithreaded PTP initiators 42 and 92 are actualized along with the DPDP layer 43, the stand alone printing controller 44 and the like.

As components of the printer 1, a DSC 2 and a DSC 3 other than those described heretofore have the same functions as those with the same names in the embodiment 1, the same reference numerals as in the embodiment 1 will be suffixed, and a description will be omitted.

Next, a description will be given of an operation of each instrument of the direct printing system according to the embodiment 2 having the configuration described heretofore.

First, a description will be given of a process of connecting the DSC 2 and the DSC 3 to the printer 1.

When the printer 1 and the DSC 2 are connected via the communication network 4, communication becomes possible between a TCP/IP portion 56 of the DSC 2 and the TCP/IP portion 31 of the printer 1. Also, communication becomes possible between a PTP/IP portion 57 of the DSC 2 and the TCP/IP portion 32 of the printer 1, and communication becomes possible between a PTP responder 58 of the DSC 2 and the PTP initiator 42 of the printer 1.

Also, when the printer 1 and the DSC 3 are connected by a USB cable 5, and communication becomes possible between the DSC 3 and the printer 1, an SICD 76 of the DSC 3 transmits a set interference command to the SICD 41 of the printer 1. The set interference command is transmitted to an SICD 91 via a USB device I/F 72 and a USB connector 22 of the DSC 3 and the USB host I/F 23. By this means, data can be transmitted and received between end points of the SICD 76 of the DSC 3 and the SICD 91 of the printer 1. Communication becomes possible between a PTP responder 77 of the DSC 3 and the PTP initiator 92 of the printer 1.

In this way, in the embodiment 2, it is possible to simultaneously connect the DSC 2 and the DSC 3 to the printer 1 at a level near a physical level of or below the PTP.

The DPDP layer 59 of the DSC 2 starts a connection process when the PTP responder 58 becomes capable of communication. The DPDP layer 59 transmits detection data for detecting the DPDP layer 43 which is to be a communication partner. The detection data is transmitted from the DSC 2 to the printer 1.

The DPDP layer 43 of the printer 1, on receiving the detection data, transmits response data to the DPDP layer 59 of the DSC 2. By this means, the DPDP layer 43 of the printer 1 recognizes that the DPDP layer 59 of the DSC 2 has been connected, and the DPDP layer 59 of the DSC 2 recognizes that the DPDP layer 43 of the printer 1 has been connected. It becomes possible for control information for the image printing in the DPDP layer to be transmitted and received between the DPDP layer 43 of the printer 1 and the DPDP layer 59 of the DSC 2, whereby direct printing via the communication network 4 becomes possible.

At this time, the exclusive controller 40b, monitoring the DPDP layer 43, in the event that neither the DPDP layer 59 of the DSC 2 or the DPDP layer 78 of the DSC 3 has been connected to the DPDP layer 43 of the printer 1, causes the DPDP layer 43 to transmit and receive the detection data and response data related to a connection process of either the DPDP layer 59 of the DSC 2 or the DPDP layer 78 of the DSC 3 as they are. However, in the event that one of the DPDP layers 59 of the DSC 2 and the DPDP layers 78 of the DSC 3 is being or has been connected to the DPDP layer 43 of the printer 1, the exclusive controller 40b blocks the detection data and response data related to the connection process of the other one with the DPDP layer 43.

Meanwhile, the DPDP layer 78 of the DSC 3 starts a connection process when the PTP responder 77 becomes capable of communication. The DPDP layer 78 transmits detection data for detecting the DPDP layer 43. The detection data is transmitted from the DSC 3 to the printer 1.

At this time, in the event that a connection process between the DPDP layer 43 of the printer 1 and the DPDP layer 59 of the DSC 2 is not being or has not already been carried out, the DPDP layer 43 receives the detection data and transmits response data to the DPDP layer 78 of the DSC 3; By this means, the DPDP layer 43 of the printer 1 recognizes that the DPDP layer 78 of the DSC 3 has been connected, and the DPDP layer 78 of the DSC 3 recognizes that the DPDP layer 43 of the printer 1 has been connected. Communication for the direct printing in the DPDP layer becomes possible between the DPDP layer 43 of the printer 1 and the DPDP layer 78 of the DSC 3.

However, in the event that a connection process between the DPDP layer 43 of the printer 1 and the DPDP layer 59 of the DSC 2 is being or has already been carried out, the detection data is blocked by the exclusive controller 40b. For this reason, the connection process of the DPDP layer 78 of the DSC 3 fails.

By means of the series of operations heretofore described, the DPDP layer 43 of the printer 1 accepts the image printing request of the DPDP layer from only whichever of the DPDP layer 59 of the DSC 2 and the DPDP layer 78 of the DSC 3 completes the connection process first.

The DPDP layer 43 of the printer 1, as well as generating a printing command based on the print job from the DPDP layer 59 of the DSC 2 or the DPDP layer 78 of the DSC 3, obtains the image files 53 and 73 specified in the print job and supplies it to the stand alone printing controller 44.

The stand alone printing controller 44, firstly, generates control data for a printing engine 29 corresponding to the printing command supplied and, using the control data generated, controls the printing engine 29. The printing engine 29 executes the printing process in accordance with the control of the stand alone printing controller 44. By this means, the printer 1 prints the image requested by the DSC 2 or the DSC 3.

As described heretofore, according to the embodiment 2, the printer 1, being connected to the communication network 4, which is the IP network, includes the TCP/IP portion 31 and the PTP/IP portion 32 which receive the image output request from the DSC 2 via the communication network 4, and the exclusive controller 40b as the exclusive control means which, in the event that the image output request from the DSC 3 and the image output request from the DSC 2 conflict, exclusively selects one thereof, and causes the DPDP layer 43 to process the selected image output request.

By this means, by having two DSCs each of which supplies the image output request to the printer 1, even in the event that the image output requests conflict, it is possible to appropriately output the image based on either of the image output requests, with no danger of one of the image output requests having a bad effect on the other image output request.

Also, according to the embodiment 2, it being possible for the SICD 41, the TCP/IP portion 31 and PTP/IP portion 32 to simultaneously establish both the communication path with the DSC 2 via the communication network 4 and the USB communication path with the DSC 3, the DPDP layer 43, by using the communication paths, detects either the DSC 2 or the DSC 3 by the connection process. Then, the exclusive controller 40b selects the image output request from whichever of the DSC 2 and the DSC 3 is detected first by the DPDP layer 43, and blocks the image output request from the remaining DSC.

By this means, there is no need to make parallel, such as by multithreading, the DPDP layer 43 which forms an upper layer, meaning that it can be easily installed.

Also, the communication layer via the communication network 4 between the TCP/IP portion 31 and the DSC 2, which forms a lower layer, and the USB communication layer between the SICD 41 and the DSC 3 are made parallel, meaning that two systems can be simultaneously connected in the lower layer. Therefore, in the event that images are outputted consecutively from differing systems, there is no need to carry out an establishment of the communication path in the lower layer again, and it is possible to immediately supply the image output request to the DPDP layer 43.

### Embodiment 3

An image output apparatus according to an embodiment 3 of the invention is configured in such a way that, in the printer 1 of the embodiment 1, PTP initiators and DPDP layers are made parallel, and an exclusive controller 40c is disposed between the DPDP layers and a stand alone printing controller 44, instead of the exclusive controller 40a.

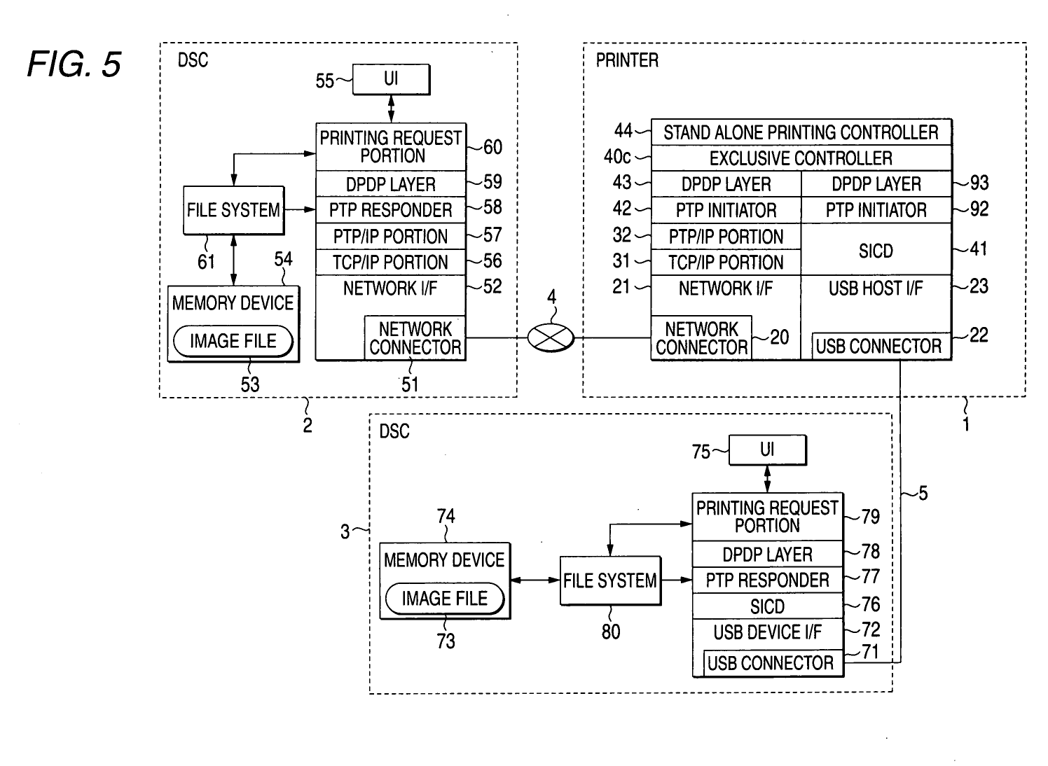

FIG. 5 is a block diagram showing a direct printing system including a printer 1 as the image output apparatus according to the embodiment 3. A hardware configuration of the printer 1 as the image output apparatus according to the embodiment 3 is identical to that in the embodiment 1. However, the main program 28 is changed to one which actualizes functions described hereafter.

The printer 1 has a network I/F 21, a TCP/IP portion 31, a PTP/IP portion 32, a USB host I/F 23, an SICD 41, two multithreaded PTP initiators 42 and 92, two multithreaded DPDP layers 43 and 93, an exclusive controller 40c and a stand alone printing controller 44. As a central processing unit 24 of a microcomputer 11 of the printer 1 loads the main program 28 stored in an ROM 26 into an RAM 25 and executes it, the TCP/IP portion 31, the PTP/IP portion 32, the SICD 41, the two multithreaded PTP initiators 42 and 92, and the two multithreaded DPDP layers 43 and 93 are actualized along with the stand alone printing controller 44 and the like.

As components of the printer 1, a DSC 2 and a DSC 3 other than those described heretofore have the same functions as those with the same names in the embodiment 2, the same reference numerals as in the embodiment 2 will be suffixed, and a description will be omitted.

Next, a description will be given of an operation of each instrument of the direct printing system according to the embodiment 3 having the configuration described heretofore.

First, a description will be given of a process of connecting the DSC 2 and the DSC 3 to the printer 1.

In the embodiment 3, in the same way as in the embodiment 2, regarding lower communication layers at or lower than the PTP, the communication path between the TCP/IP portion 31 and the DSC 2, and the communication path between the SICD 41 and the DSC 3, can be simultaneously established.

The DPDP layer 59 of the DSC 2 starts a connection process when the PTP responder 58 becomes capable of communication. The DPDP layer 59 transmits detection data for detecting the DPDP layer 43 which is to be a communication partner. The detection data is transmitted from the DSC 2 to the printer 1, and transmitted to the DPDP layer 43 of the printer 1. The DPDP layer 43 of the printer 1, on receiving the detection data, transmits response data to the DPDP layer 59 of the DSC 2.

By this means, the DPDP layer 43 of the printer 1 recognizes that the DPDP layer 59 of the DSC 2 has been connected, and the DPDP layer 59 of the DSC 2 recognizes that the DPDP layer 43 of the printer 1 has been connected. It becomes possible for control information for the image printing to be transmitted and received between the DPDP layer 43 of the printer 1 and the DPDP layer 59 of the DSC 2.

Also, the DPDP layer 78 of the DSC 3 starts a connection process when the PTP responder 77 becomes capable of communication. The DPDP layer 78 transmits detection data for detecting the DPDP layer 93 which is to be a communication partner. The detection data is transmitted from the DSC 3 to the printer 1. The DPDP layer 93 of the printer 1, on receiving the detection data, transmits response data to the DPDP layer 78 of the DSC 3.

By this means, the DPDP layer 93 of the printer 1 recognizes that the DPDP layer 78 of the DSC 3 has been connected, and the DPDP layer 78 of the DSC 3 recognizes that the DPDP layer 93 of the printer 1 has been connected. It becomes possible for control information for the image printing to be transmitted and received between the DPDP layer 93 of the printer 1 and the DPDP layer 78 of the DSC 3.

By means of the series of operations heretofore described, the printer 1 and the DSC 2, and the printer 1 and the DSC 3, can be simultaneously connected at the DPDP layer.

Next, a description will be given of the direct printing process of the image.

The printing request portion 60 of the DSC 2, on selecting the image etc., supplies the selected information to the DPDP layer 59. The DPDP layer 59 generates a print job corresponding to the selected information.

After generating the print job, the DPDP layer 59, first, in order to obtain parameters indicating whether or not a new print job can be accepted, generates a parameter request script, and transmits it to the DPDP layer 43 of the printer 1. The parameter request script is transmitted from the DSC 2 to the printer 1. The parameter request script received by the network I/F 21 of the printer 1 is supplied to the DPDP layer 43 via the TCP/IP portion 31, the PTP/IP portion 32 and the PTP initiator 42.

Based on whether or not the stand alone printing controller 44 is processing the print job, the exclusive controller 40c notifies the DPDP layer 43 of the parameter values.

The DPDP layer 43 of the printer 1 transmits the parameter values to the DPDP layer 59 of the DSC 2. The response data including the parameter values is transmitted from the printer 1 to the DSC 2 via the communication network 4.

Based on the parameter values received, the DPDP layer 59 of the DSC 2 determines whether or not the printer 1 can accept the print job. In the event that the printer 1 cannot accept the print job, the DPDP layer 59, for example, repeats the process for obtaining the parameter values after a prescribed time has elapsed.

In the event that the printer 1 can accept the print job, the DPDP layer 59 of the DSC 2 transmits the generated print job to the DPDP layer 43 of the printer 1. The DPDP layer 43 of the printer 1 generates a printing command based on the print job from the DPDP layer 59 of the DSC 2, and supplies it to the stand alone printing controller 44. The stand alone printing controller 44, firstly, generates control data for a printing engine 29 corresponding to the printing command supplied (the print job) and, using the control data generated, controls the printing engine 29. The printing engine 29 executes the printing process in accordance with the control of the stand alone printing controller 44. By this means, the printer 1 prints the image requested by the DSC 2.

Meanwhile, the printing request portion 79 of the DSC 3, on selecting the image etc., supplies the selected information to the DPDP layer 78. The DPDP layer 78 generates a print job corresponding to the selected information.

After generating the print job, the DPDP layer 78 generates a parameter request script, and transmits it to the DPDP layer 93 of the printer 1. The DPDP layer 93 of the printer 1 receives, from the exclusive controller 40c, a value based on the possibility or otherwise of accepting the stand alone printing controller 44 print job, generates response data including that value as the parameter value, and transmits it to the DPDP layer 78 of the DSC 3.

That is, the exclusive controller 40c supplies a value indicating a permission to accept the print job, in the event that the stand alone printing controller 44 is not processing the print job, and a value indicating a refusal to accept the print job, in the event that the stand alone printing controller 44 is processing the print job, to the DPDP layers 43 and 93. By this means, in the event that a print job related to an image output request from one of either the DSC 2 or the DSC 3 is being executed, the print job related to the image output request from the other is refused. However, as the printer 1 can be simultaneously connected to the DSC 2 and the DSC 3 in the DPDP layer level, a printing execution preliminary process (a notification of printing conditions from the printer 1 to the DSC etc.) can be executed between the DSC whose print job has been refused and the printer 1. As the preliminary process, a notification from the DPDP layer of the printer 1 to the DPDP layer of the DSC of option data such as a selectable paper size and paper type, a selection of an image file to be printed etc. are possible.

Based on the parameter values received, the DPDP layer 78 of the DSC 3 determines whether or not the printer 1 can accept the print job. In the event that the printer 1 cannot accept the print job, the DPDP layer 78, for example, repeats the process for obtaining the parameter values after a prescribed time has elapsed.

In the event that the printer 1 can accept the print job, the DPDP layer 78 of the DSC 3 transmits the generated print job to the DPDP layer 93 of the printer 1. The DPDP layer 93 of the printer 1 generates a printing command and supplies it to the stand alone printing controller 44. The stand alone printing controller 44 generates control data for a printing engine 29 corresponding to the printing command supplied and, using the control data generated, controls the printing engine 29. The printing engine 29 executes the printing process in accordance with the control of the stand alone printing controller 44. By this means, the printer 1 prints the image requested by the DSC 3.

As described heretofore, according to the embodiment 3, the printer 1, being connected to the communication network 4, which is the IP network, is furnished with the TCP/IP portion 31 and the PTP/IP portion 32 which receive the image output request from the DSC 2 via the communication network 4, and with the exclusive controller 40c which, in the event that the image output request from the DSC 3 and the image output request from the DSC 2 conflict, exclusively selects one thereof, and causes the DPDP layers 43 and 93 to process the selected image output request.

By this means, by having two DSCs each of which supplies the image output request to the printer 1, even in the event that the image output requests conflict, it is possible to appropriately output the image based on either of the image output requests, with no danger of one of the image output requests having a bad effect on the other image output request.

Also, according to the embodiment 3, the TCP/IP portion 31 and the SICD 41 can simultaneously establish both the communication path via the communication network 4 and the USB communication path with the DSC 3, furthermore, the DPDP layers 43 and 93 can be simultaneously connected with both the DSC 2 and the DSC 3 at a DPDP layer level above a physical level. Then, the exclusive controller 40c selects the image output request from whichever of the DSC 2 and the DSC 3 starts the transmission process of the image output request to the DPDP layers 43 and 93 first. In the embodiment 3, the obtaining of the parameter value for the possibility or otherwise of accepting the print job is carried out at the beginning of the transmission process of the image output request.

By this means, the DPDP layers 43 and 93 are arranged in a series, meaning that two systems can be simultaneously connected in the DPDP layers 43 and 93 which form an upper layer. Therefore, in the event that images are outputted consecutively from differing systems, there is no need to carry out an establishment of the communication path in the upper layer and the lower layer again, and it is possible to immediately supply the image output request to the DPDP layers 43 and 93. Also, as a connection condition is maintained between the DSC (the DSC 2 or the DSC 3) in which the image output based on the image output request is not being carried out and the DPDP layer (the DPDP layers 43 and 93), it is possible to carry out a setting process etc. of the image output between them while the image output based on the image output request from another DSC is being executed.

### Embodiment 4

An image output apparatus according to an embodiment 4 of the invention is configured by adding a job queuing portion 94 to DPDP layers 43 and 93 in the printer 1 of the embodiment 3.

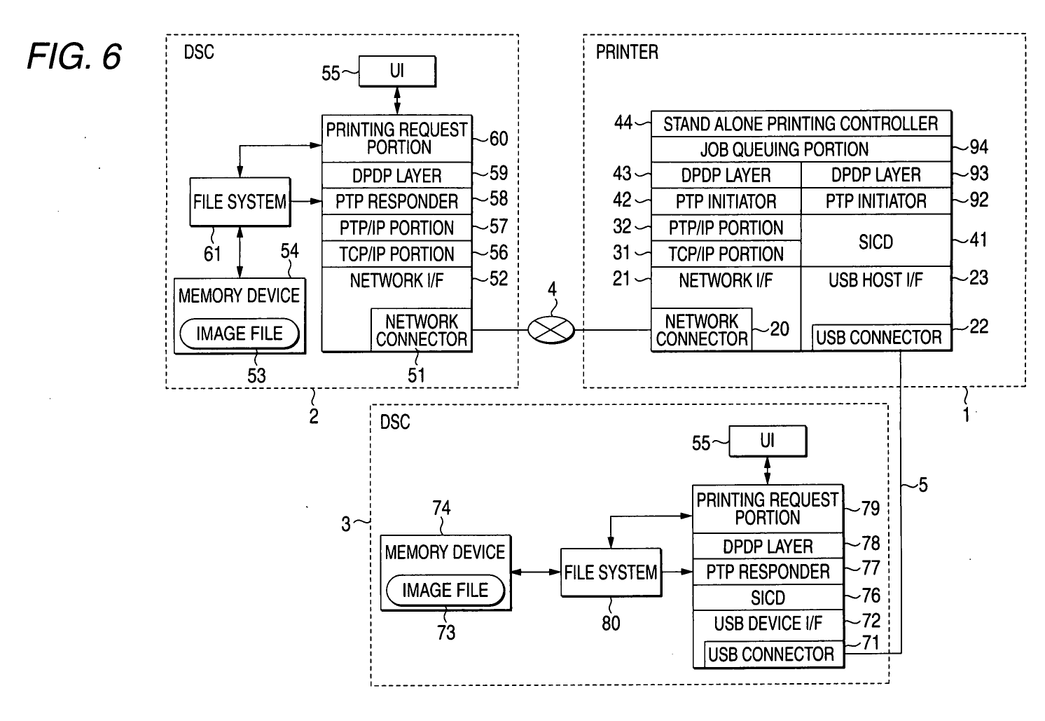

FIG. 6 is a block diagram showing a direct printing system including a printer 1 as the image output apparatus according to the embodiment 4. A hardware configuration of the printer 1 as the image output apparatus according to the embodiment 4 is identical to that in the embodiment 1. However, the main program 28 is changed to one which actualizes functions described hereafter.

The printer 1 has a network I/F 21, a TCP/IP portion 31, a PTP/IP portion 32, a USB host I/F 23, an SICD 41, two PTP initiators 42 and 92, two DPDP layers 43 and 93, a job queuing portion 94 and a stand alone printing controller 44. As a central processing unit 24 of a microcomputer 11 of the printer 1 loads the main program 28 stored in an ROM 26 into an RAM 25 and executes it, the TCP/IP portion 31, the PTP/IP portion 32, the SICD 41, the two PTP initiators 42 and 92, the two DPDP layers 43 and 93 and the job queuing portion 94 are actualized along with the stand alone printing controller 44 and the like.

The job queuing portion 94 stores a print job received by the DPDP layers 43 and 93. The job queuing portion 94 saves the print job in, for example, a memory area secured in the RAM 25.

As components of the printer 1, the DSC 2 and the DSC 3 other than those described heretofore have the same functions as those with the same names in the embodiment 3, the same reference numerals as in the embodiment 3 will be suffixed, and a description will be omitted.

Next, a description will be given of an operation of each instrument of the direct printing system according to the embodiment 4 having the configuration described heretofore.

The printer 1 and the DSC 2 are connected via a communication network 4, communication becomes possible between the printer 1 and the DSC 2, and data can be transmitted and received. Also, the DPDP layer 59 of the DSC 2 and the DPDP layer 43 of the printer 1 become able, by means of the connection process, to accept a direct printing job via the communication network 4.

Also, when the printer 1 and the DSC 3 are connected by a USB cable 5, and communication becomes possible between the DSC 3 and the printer 1, an SICD 76 of the DSC 3 and the SICD 41 of the printer 1 become able to transmit and receive data by means of a set interference command. Also, the DPDP layer 78 of the DSC 3 and the DPDP layer 93 of the printer 1 become able, by means of the connection process, to accept a direct printing job via the USB cable 5.

Next, a description will be given of the direct printing process of the image.

The printing request portion 60 of the DSC 2, on selecting the image etc., supplies the selected information to the DPDP layer 59. The DPDP layer 59 generates a print job in accordance with the selected information.

After generating the print job, the DPDP layer 59, first, in order to obtain parameter values indicating whether or not a new print job can be accepted, generates a parameter request script, and transmits it to the DPDP layer 43 of the printer 1.

The DPDP layer 43 of the printer 1 confirms with the job queuing portion 94 whether or not a queuing of the new job is possible.

Immediately after starting up the printer 1, the job queuing portion 94 has not stored the print job. The job queuing portion 94 notifies the DPDP layer 43 of the fact that the queuing is possible (that is, the fact that the print job can be accepted).

The DPDP layer 43 of the printer 1 generates response data including parameter values corresponding to the notification from the job queuing portion 94, and transmits them to the DPDP layer 59 of the DSC 2. The DPDP layer 59 of the DSC 2, based on the parameter values received, determines whether or not the printer 1 can accept the print job. In the event that the printer 1 cannot accept the print job, the DPDP layer 59, for example, repeats the process for obtaining the parameter values after a prescribed time has elapsed.

In the event that the printer 1 can accept the print job, the DPDP layer 59 of the DSC 2 transmits the generated print job to the DPDP layer 43 of the printer 1. The DPDP layer 43 of the printer 1 stores the print job from the DPDP layer 59 of the DSC 2 in the job queuing portion 94.

Subsequently, the DPDP layer 43 reads the print job from the job queuing portion 94, generates a printing command based on the print job, and supplies it to the stand alone printing controller 44. The stand alone printing controller 44 generates control data and controls the printing engine 29. The printing engine 29 executes the printing process in accordance with the control of the stand alone printing controller 44. By this means, the printer 1 prints the image requested by the DSC 2.

When the print job being queued is read by the DPDP layers 43 and 93, the job queuing portion 94 releases the memory area storing the print job. By this means, an available area of the job queuing portion 94 increases. When the available area becomes equal to or larger than a prescribed size, the parameter issued by the job queuing portion 94 is of a value wherein it is possible to accept the print job.

The printing request portion 79 of the DSC 3, on selecting the image etc., supplies the selected information to the DPDP layer 78. The DPDP layer 78 generates a print job corresponding to the selected information.

After generating the print job, the DPDP layer 78 generates a parameter request script, and transmits it to the DPDP layer 93 of the printer 1. The DPDP layer 93 of the printer 1 confirms with the job queuing portion 94 whether or not a queuing of the new job is possible.

When the print job has not been stored, or when there is a sufficient area available, the job queuing portion 94 notifies the DPDP layer 93 of the fact that the queuing is possible. Conversely, when there is an insufficient area to store the print job, the job queuing portion 94 notifies the DPDP layer 93 of the fact that the queuing is not possible.

The DPDP layer 93 of the printer 1 generates response data including parameter values corresponding to the notification from the job queuing portion 94, and transmits them to the DPDP layer 78 of the DSC 3. The DPDP layer 78 of the DSC 3, based on the parameter values received, determines whether or not the printer 1 can accept the print job.

In the event that the printer 1 cannot accept the print job, the DPDP layer 78, for example, repeats the process for obtaining the parameter values after a prescribed time has elapsed. During this time, the print job being queued by the job queuing portion 94 is read by the DPDP layers 43 and 93 and, in the event that the available area of the job queuing portion 94 increases, the parameter value changes to a value indicating that queuing is possible.

When the printer 1 is capable of printing, the DPDP layer 78 of the DSC 3 transmits the generated print job to the DPDP layer 93 of the printer 1. The DPDP layer 93 of the printer 1 stores the print job received in the job queuing portion 94.

Subsequently, the DPDP layer 93 reads the print job from the job queuing portion 94, generates a printing command based on the print job, and supplies it to the stand alone printing controller 44. The stand alone printing controller 44 generates control data and controls the printing engine 29. The printing engine 29 executes the printing process in accordance with the control of the stand alone printing controller 44. By this means, the printer 1 prints the image requested by the DSC 3.

In the description given heretofore, the job queuing portion 94 first stores the print job of the DSC 2, then stores the print job of the DSC 3. It is acceptable that the queuing order is reversed.

As described heretofore, according to the embodiment 4, the printer 1, being connected to the communication network 4, which is the IP network, is furnished with the TCP/IP portion 31 and the PTP/IP portion 32 which receive the image output request from the DSC 2 via the communication network 4, and with the job queuing portion 94 as the exclusive controlling means which, in the event that the image output request from the DSC 3 and the image output request from the DSC 2 conflict, exclusively selects the image output request from the DSC 3 and the image output request from the DSC 2 sequentially, and causes the DPDP layers 43 and 93 to process the selected image output request.

By this means, by having two DSCs each of which supplies the image output request to the printer 1, even in the event that the image output requests conflict, it is possible to appropriately output the image based on either of the image output requests, with no danger of one of the image output requests having a bad effect on the other image output request.

Also, according to the embodiment 4, the job queuing portion 94 as job queuing means queues the image output request from the DSC 2 and the DSC 3 and, every time the image output based on the image output request is finished, sequentially outputs the next image output request from the queue to the DPD layers 43 and 93.

By this means, by having two DSCs each of which supplies the image output request to the printer 1, even in the event that the image output requests conflict, it is possible to appropriately output the images sequentially based on each of the image output requests by means of the queuing.

Also, when there is an insufficient memory area to store the print job, the job queuing portion 94 notifies of the fact that the queuing of a new job is not possible. Consequently, in the event that the image output request from the DSC 3 and the image output request from the DSC 2 conflict, the printer 1 can queue within a possible range and, when a queuing of every job is not possible, makes a later printing request wait by a first come first served exclusive control then, when the earlier printing process is complete, queues the print job which has been made to wait and prints it.

Also, the DSC 2 and the DSC 3 can independently carry out a process from a selection of the image to a transmission of the print job, regardless of whether or not the printer 1 is in a printing condition. The DSC 2 and the DSC 3 can complete the printing process even though the printer 1 is in the process of printing.

Although each of the embodiments described heretofore is an example of a preferred embodiment of the invention, the invention is not limited to this, as various modifications and changes are possible without departing from the scope of the invention.

For example, in each of the embodiments described heretofore, the DSC which is first connected and first transmits the image output request is given priority to become capable of printing. As a further example, it is acceptable that the DPDP layers 43 and 93 of the printer 1 are preferentially connected in advance by a user or by a fixed setting order, so as to generate a printing command based on the image output request. In the case of this modified example, it is possible to preferentially process the image output request of one of them.

In each of the embodiments described heretofore, each of the DSC 2 and DSC 3, once making an image output request, complete the process. As a further example, it is acceptable that each of the DSC 2 and DSC 3, after making an image output request, displays a printing condition of the image. In this case, it is preferable that the DPDP layers 59 of the DSC 2 and the DPDP layers 78 of the DSC 3, after transmitting the print job, periodically enquire to the DPDP layers 43 and 93 of the printer 1 about a state of progress of the printing.

Especially, in the embodiments 3 and 4, the printer has two DPDP layers 43 and 93. It is necessary for the two DPDP layers 43 and 93 to evaluate the DSC 2 and DSC 3 (job owners) which have transmitted the print job to each of them, and to reply to the enquiry.

In each of the embodiments described heretofore, the DSC 2 and DSC 3 are connected to the printer 1, wherein the DSC 2 and DSC 3 transmit the print job as the image output request to the printer 1. Apart from this, for example, it is also acceptable to connect a storage device capable of being connected to a network or USB, a portable telephone terminal, a PDA, a scanner, a personal computer etc. to the printer 1, and use it as the image output request apparatus which transmits the print job to the printer 1.

In each of the embodiments described heretofore, the printer 1 executes the image output by printing the image, but it is also acceptable that the image output apparatus has a form not of a printer, but of a display device, a projection device etc. In this case, it is preferable that a display or a projector, and a drive device thereof, are provided instead of the printing engine 29 in FIG. 1.

The invention can be applied to, for example, a direct printing system which prints an image by connecting a digital still camera and a printer, and the like.

What is claimed is:

1. An image output apparatus comprising:
a first communicator, operable to receive a first image output request transmitted from a first image output request apparatus by a first communication method;
a second communicator, operable to receive a second image output request transmitted from a second image output request apparatus by a second communication method;
a controller, operable to select one of the first image output request and the second image output request in a case where the first image output request and the second image output request conflict; and
a processor, operable to generate control information for performing image output in accordance with the selected image output request.

2. The image output apparatus according to claim 1, wherein
the processor detects the first image output request apparatus based on a first communication path between the first communicator and the first image output request apparatus,
the processor detects the second image output request apparatus based on a second communication path between the second communicator and the second image output request apparatus,
the controller selects the first image output request in a case where the first communication path is established before the second communication path is established, and
the controller selects the second image output request in a case where the second communication path is established before the first communication path is established.

3. The image output apparatus according to claim 1, wherein
the first communicator establishes a first communication path between the first communicator and the first image output request apparatus,
the second communicator establishes a second communication path between the second communicator and the second image output request apparatus,
the processor detects the first image output request apparatus based on the first communication path,
the processor detects the second image output request apparatus based on the second communication path,
the controller selects the first image output request in a case where the first communication path is detected before the second communication path is detected, and
the controller selects the second image output request in a case where the second communication path is detected before the first communication path is detected.

4. The image output apparatus according to claim 1, wherein
the first communicator establishes a first communication path between the first communicator and the first image output request apparatus,
the second communicator establishes a second communication path between the second communicator and the second image output request apparatus,
the processor detects the first image output request apparatus based on the first communication path,
the processor detects the second image output request apparatus based on the second communication path,
the controller selects the first image output request in a case where the first image output request apparatus starts to transmit the first image output request before the second image output request apparatus starts to transmit the second image output request, and
the controller selects the second image output request in a case where the second image output request apparatus starts to transmit the second image output request before the first image output request apparatus starts to transmit the first image output request.

5. The image output apparatus according to claim 1, wherein
the first communicator establishes a first communication path between the first communicator and the first image output request apparatus,
the second communicator establishes a second communication path between the second communicator and the second image output request apparatus,
the processor detects the first image output request apparatus based on the first communication path,
the processor detects the second image output request apparatus based on the second communication path, and
the controller includes a queuer which queues the first image output request and the second image output request.

6. The image output apparatus according to claim 1, wherein
until the image output based on one of the first image output request and the second image output request is finished, the controller blocks the other one of the first image output request and the second image output request.

7. The image output apparatus according to claim 1, wherein
the controller preferentially selects one of the first image output request and the second image output request based on a predetermined set order.

8. An image output method comprising:
receiving a first image output request from a first image output request apparatus;
receiving a second image output request from a second image output request apparatus;
selecting one of the first image output request and the second image output request in a case where the first image output request and the second image output request conflict; and
generating control information for performing image output in accordance with the selected image output request.
